(19) United States
(12) Patent Application Publication
(10) Pub. No.: US 2005/0176617 A1
(43) Pub. Date: Aug. 11, 2005

(54) High efficiency laundry detergent

(76) Inventors: Daniel Wood, Phoenix, AZ (US); Aurora Stamper, Phoenix, AZ (US)

Correspondence Address: SNELL & WILMER, LLP, ONE ARIZONA CENTER, 400 E. VAN BUREN, PHOENIZ, AZ, 85004-2202, US

(21) Appl. No.: 10/778,000

(22) Filed: Feb. 10, 2004

(51) Int. Cl. C11D 3/37

(52) U.S. Cl. 510/475

(57) ABSTRACT

A high efficiency laundry detergent in accordance with various aspects of the present invention comprises a nonionic surfactant component, which comprises at least two distinct nonionic surfactants optimized to control cleaning and the foam level, an anionic surfactant component, a polymer component, a builder, a chelating agent, and a liquid carrier.

### FIELD OF INVENTION

The present invention relates generally to a liquid laundry detergent composition and more particularly, to a liquid laundry detergent composition for use in high efficiency washers.

### BACKGROUND OF THE INVENTION

Many laundry detergents have relatively high amounts of surfactants. Often the amounts reach 10% or greater by weight of the composition. Among other things, surfactants promote and facilitate the removal of soils and stains from fabric articles laundered in solutions containing such detergents and water. Often, laundry detergents contain more than one type of surfactant, such as, for example, nonionic and anionic surfactants.

The anionic surfactants tend to create a foamy effect during the washing of fabric articles in a laundering process. In high efficiency washing machines, which use considerably less water than traditional machines, the traditional laundry detergents, with the high amount of surfactants, produce copious amounts foam. Therefore, the amount of surfactant for laundry detergents for use in high efficiency machines must be less.

However, the use of anionic surfactants still can cause excess foaming, even when used in amounts less than traditionally used. Therefore, many laundry detergent compositions contain suds suppressing materials.

What is needed in the art is a liquid laundry detergent composition that achieves the performance of traditional detergents with large amounts of surfactants, for use in high efficiency washing machines, and is able to contain the amount of suds without the use of a traditional suds suppressor.

### SUMMARY OF THE INVENTION

The present invention provides a liquid laundry detergent. The liquid laundry detergent composition comprises a nonionic surfactant component, an anionic surfactant component, a polymer component, a builder, a chelating agent, and a liquid carrier.

In accordance with one aspect of the exemplary embodiment of the present invention, the anionic surfactant component is present in the amount of from about 0.5% to about 5% by weight of the composition; the nonionic surfactant is present in an amount less than about 15% by weight of the composition; the polymer component is present in the amount of from about 0.2% to about 2% by weight of the composition; the builder is present in the amount of from about 0.01% to about 5% by weight of the composition; the chelating agent is from about 0.01% to about 5% by weight of the composition; and a liquid carrier, e.g., water, comprises the balance of the composition. In yet another aspect of this exemplary embodiment of the present invention, the liquid laundry detergent composition may also comprise one or more optional additives, such as, for example, a dying agent, a fragrance, a preservative, and the like.

### DETAILED DESCRIPTION

The following description is of an exemplary embodiment of the invention only, and is not intended to limit the scope, applicability, or configuration of the invention in any way. Rather, the following description is intended to provide a convenient illustration for implementing various aspects of an exemplary embodiment of the invention. As will become apparent, changes may be made in the function and arrangement of the elements described in this embodiment without departing from the spirit and scope of the invention.

In accordance with an aspect of the exemplary embodiment of the present invention, a high efficiency laundry detergent in accordance with various aspects of the present invention comprises a nonionic surfactant component, which comprises at least two distinct nonionic surfactants optimized to control cleaning and the foam level, an anionic surfactant component, a polymer component, a builder, a chelating agent, and a liquid carrier.

The nonionic surfactant component is preferably present in the an amount less than about 15% by weight of the composition. For example, preferably, the nonionic surfactant component is present in the amount from about 0.75% to about 10% by weight of the composition, and most preferably is present in the amount from about 1% to about 5% by weight of the composition.

In one aspect of the exemplary embodiment of the present invention, the nonionic surfactant component may comprise a “traditional” nonionic surfactant. More preferably, the traditional nonionic surfactant comprises a C14-18 ethoxylated alcohol of empirical formula C₁₆H₃₂(OCH₂CH₂)₇OH. Optimally, the nonionic surfactant used is Sulfonic HDL-90.

In another aspect of the preferred embodiment of the present invention, the traditional nonionic surfactant comprises from about 50% to about 85% of the weight of the nonionic surfactant component. More preferably, the traditional nonionic surfactant comprises from about 55% to about 80% of the weight of the nonionic surfactant component, and optimally comprises from about 60% to about 75% of the weight of the nonionic surfactant component.

In another aspect of the exemplary embodiment of the present invention, the nonionic surfactant component may comprise at least two nonionic materials. The second nonionic surfactant component may comprise an “oily” nonionic surfactant. Preferably, the “oily” nonionic surfactant comprises a C12-13 ethoxylated and propoxylated alcohol with a generic structure of R—O-(EO)x-(PO)y-H. Optimally, the oily nonionic surfactant used is Nonidet RK18, manufactured by Tomah Ind.

In yet another aspect of the exemplary embodiment, the oily nonionic surfactant comprises from about 15% to about 50% of the weight of the nonionic surfactant component. More preferably, the oily nonionic surfactant comprises from about 20% to about 45% of the weight of the nonionic surfactant component, and optimally comprises from about 25% to about 40% of the weight of the nonionic surfactant component.

The anionic surfactant component is present in amounts equal to or above a minimum amount at which at least partial removal of stains and soils occurs. The anionic surfactant component is also preferably present in an amount less than the amount at which substantial redeposition of soil occurs. As a preferred aspect of the present invention, the anionic surfactant component is present in the an amount of from about 0.5% to about 5% by weight of the composition. More preferably, the anionic surfactant component is present in the amount from about 0.75% to about 4% by weight of the composition, and most preferably is present in the amount from about 1% to about 3% by weight of the composition.

Optimally, in the preferred embodiment of the present invention, the anionic surfactant component comprises sodium dodecylbenzene sulfonate. However, it should be appreciated that any anionic surfactant similar to sodium dodecylbenzene sulfonate in structure and performance may be used. This includes, but is not limited to, any linear alkyl benzene sulfonate (LAS) material having about 8 to about 14 carbon atoms, or combinations of LAS having about 8 to about 14 carbon atoms.

Furthermore, the exemplary embodiment of the present invention has a ratio of anionic surfactant component to nonionic surfactant component from about 2:1 to about 1:5. More preferably, the ratio of the anionic surfactant component to the nonionic surfactant component is from about 1:1 to about 1:4. Optimally, the ratio is from about 1:1 to about 1:3.

The polymer component is present in the an amount of from about 0.2% to about 2% by weight of the composition. More preferably, the polymer component is present in the amount from about 0.3% to about 1.9% by weight of the composition, and most preferably is present in the amount from about 0.5% to about 1.55% by weight of the composition.

The polymer component may comprise at least two polymer materials. In one exemplary embodiment of the present invention, the first polymeric material may comprise a thickening polymer. Optimally, the thickening polymer comprises Acusol 801s, manufactured by Rohm & Haas.

In a preferred aspect of the exemplary embodiment of the present invention, the thickening polymer comprises from about 65% to about 95% of the weight of the polymer component. More preferably, the thickening polymer comprises from about 70% to about 90% of the weight of the polymer component, and optimally comprises from about 80% to about 90% of the weight of the polymer component.

Furthermore, in the exemplary embodiment of the present invention, the second polymer material may comprise an antiredeposition polymer. Optimally, the antiredeposition polymer comprises sodium polyacrylate of empirical formula Na(C₃H₄O₂)₆₂.

In the preferred embodiment of the present invention, the antiredeposition polymer comprises from about 5% to about 35% of the weight of the polymer component. More preferably, the antiredeposition polymer comprises from about 10% to about 30% of the weight of the polymer component, and optimally comprises from about 15% to about 25% of the weight of the polymer component.

As a preferred aspect of the present invention, the builder is present in the amount from about 0.01% to about 5% by weight of the composition. More preferably, the builder is present in the amount from about 0.01% to about 2% by weight of the composition, and most preferably from about 1.0 to about 2.0% by weight of the composition.

The builder preferably comprises an inorganic builder. More preferably, the builder comprises an inorganic carbonate builder. Optimally, the builder comprises sodium carbonate. It should be appreciated, however, that any suitable builder may be used.

A preferred aspect of the present invention is that the chelating agent is present in the amount from about 0.01% to about 5% by weight of the composition. More preferably, the anionic surfactant component is present in the amount from about 0.01% to about 1% by weight of the composition, and most preferably is present on the order of about 0.08% by weight of the composition. Preferred chelating agents according to the present invention can be selected from the group consisting of amino carboxylates, amino phosphonates, polyunctionally substituted aromatic chelating agents and mixtures thereof, all as hereinafter defined and all preferably in their acidic form.

In the preferred embodiment of the present invention, the chelating agent is selected from the following amino carboxylates: ethylenediaminetetraacetic acid (EDTA), N-hydroxyethylenediaminetriacetates, nitrilotriacetates (NTA), ethylenediamine tetraproprionates, ethylenediamine-N,N′-diglutameates, 2-hydroxypropylenediamine-N,N′-disuccinates, trieethylenetetraaminehexacetates, diethylenetriaminepentaacetates (DPTA), and ethanoldiglycines, including their water-soluble salts such as the alkali metal, ammonium, and substituted ammonium salts thereof and mixtures thereof. Optimally, the chelating agent is EDTA.

In the preferred embodiment of the present invention the caustic agent is present in the amount from about 0.01% to about 0.1% by weight of the composition. More preferably, the anionic surfactant component is present in the amount from about 0.01% to about 0.05% by weight of the composition, and most preferably is present on the order of about 0.018% by weight of the composition. Optimally, the caustic agent comprises sodium hydroxide. It should be noted, however, that any caustic agent known in the art can be used.

The preferred liquid carrier for use in accordance with the exemplary embodiment of the present invention is water, which can be distilled, deionized, or unrefined tap water. In a preferred aspect of an exemplary embodiment, the liquid carrier comprises at least about 90% by weight of composition; however, so long as sufficient water is present in the composition, less water may be used. It should be appreciated that any liquid carrier known in the art may be used.

Other preferred aspects of the exemplary embodiment of the present invention may include one or more other common additives, such as, for example, dying agents, optical brighteners, fragrances, preservatives, and the like. One or more of such additives may be present in any amount suitable to achieve a particular objective.

The following is a non-limiting example of the exemplary embodiment of the present invention.

| Component | Weight % |
|---|---|
| Acusol 801s | 0.700 |
| Sodium Hydroxide | 0.018 |
| Sodium Dodecylbenzenesulfonate | 2.300 |
| Nonidet RK18 | 0.750 |
| Sulfonic HDL-90 | 1.900 |
| EDTA | 0.080 |
| Sodium Carbonate | 1.500 |
| Sodium Polyacrylate | 0.149 |
| Liquitint Blue HP | 0.005 |
| Tinopal CBS | 0.020 |
| Fragrance | 0.250 |
| Neolone M-10 | 0.005 |
| Deionized Water | 92.323 |

The following is another non-limiting example of the exemplary embodiment of the present invention.

| Component | Weight % |
|---|---|
| Acusol 801s | 0.700 |
| Sodium Hydroxide | 0.018 |
| Sodium Dodecylbenzenesulfonate | 1.800 |
| Nonidet RK18 | 1.200 |
| Sulfonic HDL-90 | 2.100 |
| EDTA | 0.080 |
| Sodium Carbonate | 1.000 |
| Sodium Polyacrylate | 0.198 |
| Liquitint Blue HP | 0.005 |
| Tinopal CBS | 0.020 |
| Fragrance | 0.240 |
| Neolone M-10 | 0.005 |
| Deionized Water | 92.634 |

A detergent, composition according to various aspects of the present invention may be prepared by first mixing the thickening polymer (801S) with the total water to be added and with sufficient Sodium Hydroxide to thicken it to optimum. Then adding the surfactants by any convenient method of mixing, such as, for example, by rapidly stirring with a mechanical stirrer or by agitating with a mechanical agitator. Other components, such as the EDTA, inorganic materials, the remaining polymer and optical brightener should be added near the end of the manufacturing process with sufficient mixing to promote a clear homogeneous mixture. Dye and Fragrance will be added as needed.

It should be understood that the foregoing description of the present invention is of the preferred embodiment of the present invention, and the description is not intended to limit the scope of the invention. The examples of the preferred embodiment are for illustrative purposes only, and the present invention is not limited to the specific examples and compositions set forth herein. Various modifications may be made in light thereof as will be suggested to persons skilled in the art without departing from the scope of the invention as expressed in the claims.

1. A liquid laundry detergent composition comprising:
an anionic surfactant component present in an amount of from about 0.5% to about 0.5% by weight of the composition;
a nonionic surfactant component present in an amount of less than about 15% by weight of the composition;
a polymer component present in the amount of from about 0.2% to about 2% by weight of the composition;
a builder present in the amount of from about 0.01% to about 5% by weight of the composition;
a chelating agent present in the amount of from about 0.01% to about 5% by weight of the composition; and
a liquid carrier.

2. The composition of claim 1, wherein said nonionic surfactant component comprises at least one of an oily nonionic surfactant, a traditional laundry nonionic surfactant, and mixtures thereof.

3. The composition of claim 1, wherein said nonionic surfactant component comprises a mixture of two nonionic surfactants.

4. The composition of claim 3, wherein said nonionic surfactant component comprises an oily nonionic surfactant and a traditional laundry nonionic surfactant.

5. The composition of claim 1, wherein the ration of said anionic surfactant component to said nonionic surfactant component is from about 2:1 to about 1:5.

6. The composition of claim 1, wherein said polymer component comprises at least one of a thickening polymer, an antiredeposition polymer, and mixtures thereof.

7. The composition of claim 1, wherein said polymer component comprises a mixture of two polymers.

8. The composition of claim 7, wherein said polymer component comprises a thickening polymer and a antiredeposition polymer.

9. The composition of claim 1, further comprising a caustic agent.

10. The composition of claim 9, wherein said caustic agent comprises. NaOH.

11. The composition of claim 1, further comprising an optical brightener.

12. The composition of claim 1, wherein said liquid carrier is comprised of one of water, distilled water, and deionized water.

13. The composition of claim 1, further comprising at least one of a dying agent, a fragrance, a preservative, and mixtures thereof.

14. A liquid laundry detergent composition comprising:
an anionic surfactant component present in an amount of from about 0.5% to about 5% by weight of the composition;
a nonionic surfactant component present in an amount of less than about 15% by weight of the composition, comprising at least one of an oily nonionic surfactant, a traditional laundry nonionic surfactant, and mixtures thereof;
wherein the ratio of said anionic surfactant component to said nonionic surfactant component is from about 2:1 to about 1:5; and
wherein the composition does not comprise any additional suds reducers.

15. The composition of claim 14, wherein said nonionic surfactant component comprises at least one of an oily nonionic surfactant, a traditional laundry nonionic surfactant, and mixtures thereof.

16. The composition of claim 14, wherein said nonionic surfactant component comprises a mixture of two nonionic surfactants.

17. The composition of claim 16, wherein said nonionic surfactant component comprises an oily nonionic surfactant and a traditional laundry nonionic surfactant.

18. The composition of claim 14, further comprising a polymer component present in the amount of from about 0.2% to about 2% by weight of the composition.

19. The composition of claim 18, wherein said polymer component comprises at least one of a thickening polymer, an antiredeposition polymer, and mixtures thereof.

20. The composition of claim 14, further comprising a builder present in the amount of from about 0.61% to about 5% by weight of the composition.

21. The composition of claim 14, further comprising a chelating agent present in the amount of from about 0.01% to about 5% by weight of the composition.

22. The composition of claim 14, further comprising a caustic agent.

23. The composition of claim 22, wherein said caustic agent comprises NaOH.

24. The composition of claim 14, further comprising an optical brightener.

25. The composition of claim 14, further comprising a liquid carrier comprised of one of water, distilled water, and deionized water.

26. The composition of claim 14, further comprising at least one of a dying agent, a fragrance, a preservative, and mixtures thereof.
